(19) United States
(12) Patent Application Publication
(10) Pub. No.: US 2012/0113186 A1
(43) Pub. Date: May 10, 2012

(54) COATING DEVICE AND INK JET RECORDING APPARATUS

(75) Inventors: Takashi FUKUI, Kanagawa (JP); Kouki NOMURA, Kanagawa (JP)

(73) Assignee: FUJIFILM CORPORATION, Tokyo (JP)

(21) Appl. No.: 13/292,596

(22) Filed: Nov. 9, 2011

(30) Foreign Application Priority Data
Nov. 10, 2010 (JP) 2010-251877

(51) Int. Cl. B41J 2/015; B05C 11/00; B05C 1/08

(52) U.S. Cl. 347/20; 118/262; 118/708

(57) ABSTRACT

Provided are a coating device and an ink jet recording apparatus which are capable of stably coating process liquid in a good state. In a coating device that draws up process liquid reserved in a process liquid vessel by a drawing-up roller to supply the process liquid to a coating roller, the inside of the process liquid vessel is divided into a reservoir and a recovery chamber by a partition plate, and the process liquid is circulated and supplied so as to always overflow to the recovery chamber side. Thereby, the liquid level thereof can be always maintained constant, and the process liquid can be stably coated. In addition, since the process liquid is circulated and supplied, the liquid concentration and the liquid temperature can be easily controlled.

### BACKGROUND OF THE INVENTION

1. Field of the Invention

The present invention relates to a coating device, and particularly relates to a coating device for coating process liquid to paper in an ink jet printer that performs printing on normal printing paper using an ink jet method.

2. Description of the Related Art

Ink jet recording apparatuses are known in which a predetermined process liquid is coated to paper before printing, thereby allowing normal printing paper (which is not specialty ink jet paper, but paper (cellulose-based paper, such as high-quality paper, coated paper, and art paper) used in normal offset printing and the like) to be used.

In this kind of ink jet recording apparatuses, a predetermined coating device is incorporated, and after process liquid is coated to the printing surface of the paper by the coating device, drawing is performed by ejecting ink drops.

Although various methods such as a spray method that performs coating using a spray or an ink jet method that performs coating using an ink jet head exist as coating devices, a roller coating method that performs the coating using a coating roller is relatively often adopted therein.

JP2002-96454A proposes a method of, in a roller coating-type coating device, drawing up process liquid reserved in a process liquid vessel by a drawing-up roller to supply the process liquid to a coating roller, and bringing the coating roller to which the process liquid is supplied into contact with the printing surface of paper in transport to coat the process liquid to the printing surface of paper. In addition, JP2002-96454A proposes that as a method of maintaining the process liquid reserved in the process liquid vessel constant, the liquid level of the process liquid is detected and a shortfall is sequentially replenished, to thereby maintain the liquid level of the process liquid reserved in the process liquid vessel constant.

Although the coating device disclosed in JP2002-96454A can maintain the liquid level of the process liquid reserved in the process liquid vessel constant, there is a drawback that the liquid concentration is not easily controlled because the coating device merely replenishes a shortfall. In addition, when the process liquid is left for a long period of time as is, there is also a drawback that the process liquid is deteriorated.

The present invention is contrived in view of such circumstances, and an object thereof is to provide a coating device and an ink jet recording apparatus capable of stably coating process liquid in a good state.

### SUMMARY OF THE INVENTION

In order to achieve the above-mentioned object, in a first aspect of the present invention, there is provided a coating device that coats process liquid to paper before printing, including: a coating roller that coats the process liquid to the paper; a process liquid vessel in which the inside thereof is partitioned into a reservoir and a recovery chamber by a partition plate having a predetermined height, a supply port of the process liquid is formed in the reservoir and a recovery port of the process liquid is formed in the recovery chamber, and the liquid level of the process liquid reserved in the reservoir is held constant by causing the process liquid supplied from the supply port to the reservoir to overflow from the partition plate to the recovery chamber; process liquid supply unit that supplies the process liquid to the process liquid vessel through the supply port; process liquid recovery unit that recovers the process liquid from the process liquid vessel through the recovery port; and a drawing-up roller that draws up the process liquid reserved in the reservoir of the process liquid vessel to supply the process liquid to the coating roller.

According to the coating device of the first aspect of the present invention, the inside of the process liquid vessel is partitioned into the reservoir and the recovery chamber by the partition plate. The process liquid is supplied from the supply port formed in the reservoir. The process liquid supplied to the reservoir overflows from the partition plate to the recovery chamber, and is recovered from the recovery port formed in the recovery chamber. Thereby, the process liquid having a constant liquid level is always reserved in the reservoir. In addition, the process liquid reserved in the reservoir can be always maintained in a stable state without a change in concentration or the deterioration, since the supply and the overflow thereof are always repeated. The process liquid reserved in the reservoir is drawn up by the drawing-up roller and is supplied to the coating roller. Therefore, the process liquid can be always coated in a good state to the paper.

In addition, the coating device according to the first aspect of the present invention further includes a process liquid tank that reserves the process liquid, wherein it is preferable that the process liquid supply unit supply the process liquid from the process liquid tank to the process liquid vessel, and the process liquid recovery unit recovers the process liquid from the process liquid vessel to the process liquid tank.

According to such a coating device, the process liquid is circulated and supplied to the process liquid vessel through the process liquid tank. Thereby, the structure can be simplified, and the process liquid can be stably supplied for a long period of time.

Further, in the coating device according to the first aspect of the present invention, it is preferable that the process liquid vessel is formed in a rectangular dish shape having a width corresponding to a width of the drawing-up roller, the inside thereof being partitioned into the reservoir and the recovery chamber by the partition plate disposed parallel to a shaft of the drawing-up roller, and an opening area of the recovery chamber being formed so as to be smaller than an opening area of the reservoir.

According to such a coating device, the process liquid vessel is formed in a rectangular dish shape having a width corresponding to a width (axial length) of the drawing-up roller. Thereby, the process liquid vessel can be formed to have the minimum required opening area, and evaporation of the process liquid from the process liquid vessel can be suppressed. In addition, the inside thereof is partitioned into the reservoir and the recovery chamber by the partition plate disposed parallel to the shaft of the drawing-up roller. Thereby, the process liquid can be caused to uniformly overflow in the width direction of the drawing-up roller, and thus the process liquid can be stably supplied. In addition, the opening area of the recovery chamber partitioned by the partition plate is formed so as to be smaller than the opening area of the reservoir. That is, the area is formed to be the minimum required opening area. Thereby, the evaporation from the recovery chamber can also be suppressed to a minimum. Meanwhile, the opening area of the reservoir is set to a necessary and sufficient size in consideration of the diameter of the drawing-up roller, the immersion depth and the like, and the opening area of the recovery chamber is set to a necessary and sufficient size in consideration of the amount of the process liquid which is overflowed. Preferably, the opening area is set to be the minimum required size for both, the reservoir is set to have the minimum opening area in the opening area capable of immersing the drawing-up roller by a predetermined depth, and the recovery chamber is set to have the minimum opening area in the opening area capable of recovering the overflowing process liquid.

Further, in the coating device according to the first aspect of the present invention, it is preferable that the supply port is formed in an outer circumferential wall constituting the process liquid vessel, and a blocking member for blocking the flow of the process liquid from the supply port toward the coating roller on the liquid level is provided in the inside of the process liquid vessel.

According to such a coating device of the present invention, the supply port is formed in the outer circumferential wall constituting the process liquid vessel. The blocking member is provided within the process liquid vessel so as to block the flow of the process liquid from the supply port toward the coating roller on the liquid level. When the process liquid is supplied from the supply port, there may be a case in which foam is concomitantly generated in the process liquid. When the foam is attached to the coating roller, coating unevenness is caused. According to the present invention, the flow of the process liquid from the supply port toward the coating roller on the liquid level can be blocked by the blocking member. Thereby, the foam generated with the supply of the process liquid can be prevented from being attached to the coating roller in the flow of the process liquid supplied from the supply port.

Further, in the coating device according the first aspect of the present invention, a recovery plate that recovers the process liquid leaking from the process liquid vessel is preferably included in the lower portion of the process liquid vessel.

According to such a coating device, the recovery plate is included in the lower portion of the process liquid vessel. Thereby, even when the process liquid leaks, the periphery thereof can be prevented from being contaminated. Particularly, when the process liquid shows strong acidity, there is concern that the leakage thereof may cause corrosion and the like, and thus these dangers can also be avoided.

Further, in the coating device according to the first aspect of the present invention, temperature regulation unit that regulates a temperature of the process liquid supplied to the process liquid vessel is preferably included.

According to such an coating device, the temperature-regulated process liquid can be coated. The temperature-regulated process liquid easily evaporates, but the evaporation thereof can be suppressed according to the present invention. In addition, the opening area can be reduced, whereby the temperature change can also be suppressed, and the temperature control can also be easily performed.

Furthermore, in order to achieve the above-mentioned object, in a second aspect of the present invention, there is provided a coating device that coats process liquid to paper before printing, including: a coating roller that coats the process liquid to the paper; a process liquid vessel in which the process liquid is reserved; a drawing-up roller that draws up the process liquid reserved in the process liquid vessel to supply the process liquid to the coating roller; detection unit that detects the liquid level of the process liquid reserved in the process liquid vessel; process liquid supply unit that supplies the process liquid to the process liquid vessel; process liquid recovery unit that recovers the process liquid from the process liquid vessel; and control unit that controls the supply of the process liquid by the process liquid supply unit and the recovery of the process liquid by the process liquid recovery unit, based on a detection result of the detection unit so as for the liquid level of the process liquid reserved in the process liquid vessel to be held constant.

According to the second aspect of the present invention, the liquid level of the process liquid reserved in the process liquid vessel is detected, and the supply and the recovery of the process liquid are controlled so that the liquid level is always maintained constant. Thereby, process liquid having a constant liquid level is always reserved in the process liquid vessel. In addition, since the supply and the recovery thereof is always repeated in the process liquid vessel, the reserved process liquid can be always maintained in a stable state. The process liquid reserved in the process liquid vessel is drawn up by the drawing-up roller and is supplied to the coating roller. Therefore, the process liquid can be always coated in a good state to the paper.

Further, the coating device according to the second aspect of the present invention further includes a process liquid tank that reserves the process liquid, wherein it is preferable that the process liquid supply unit supplies the process liquid from the process liquid tank to the process liquid vessel, and the process liquid recovery unit recovers the process liquid from the process liquid vessel to the process liquid tank.

According to such a coating device, the process liquid is circulated and supplied to the process liquid vessel through the process liquid tank. Thereby, the structure can be simplified, and the process liquid can be stably supplied for a long period of time.

Further, in the coating device according to the second aspect of the present invention, it is preferable that the process liquid vessel is formed in a rectangular dish shape having a width corresponding to a width of the drawing-up roller, a supply port of the process liquid is formed in an outer circumferential wall constituting the process liquid vessel, and a blocking member for blocking the flow of the process liquid from the supply port toward the coating roller on the liquid level is provided in the inside of the process liquid vessel.

According to such a coating device, the process liquid vessel is formed in a rectangular dish shape having a width corresponding to the width (axial length) of the drawing-up roller. Thereby, the process liquid vessel can be formed to have the minimum required opening area, and evaporation of the process liquid from the process liquid vessel can be suppressed. In addition, the supply port of the process liquid is formed in the outer circumferential wall constituting the process liquid vessel. The blocking member is provided within the process liquid vessel so as to block the flow of the process liquid from the supply port toward the coating roller on the liquid level. Thereby, the foam generated with the supply of the process liquid can be prevented from being attached to the coating roller in the flow of the process liquid supplied from the supply port.

Further, in the coating device according to the second aspect of the present invention, a recovery plate that recovers the process liquid leaking from the process liquid vessel is preferably included in the lower portion of the process liquid vessel.

According to such a coating device, the recovery plate is included in the lower portion of the process liquid vessel. Thereby, even when the process liquid leaks, the periphery thereof can be prevented from being contaminated. Particularly, when the process liquid shows strong acidity, there is concern that the leakage thereof may cause corrosion and the like, and thus these dangers can also be avoided.

Further, in the coating device according to the second aspect of the present invention, temperature regulation unit that regulates a temperature of the process liquid supplied to the process liquid vessel is preferably included.

According to such a coating device, the temperature-regulated process liquid can be coated. The temperature-regulated process liquid easily evaporates, but the evaporation thereof can be suppressed according to the present invention. In addition, the opening area can be reduced, whereby the temperature change can also be suppressed, and the temperature control can also be easily performed.

Further, in order to achieve the above-mentioned object, in a third aspect of the present invention, there is provided an ink jet recording apparatus that ejects ink drops from an ink jet head toward paper transported by transport unit to draw an image, including the coating device according to the above-mentioned first and second aspects of the present invention.

According to the present invention, the process liquid can be stably coated in a good state, and thus high-quality printing can be performed.

According to the present invention, process liquid can be stably coated in a good state.

### BRIEF DESCRIPTION OF THE DRAWINGS

FIG. 1 is an overall configuration diagram illustrating an ink jet recording apparatus.

FIG. 2 is a block diagram illustrating a schematic configuration of a control system of the ink jet recording apparatus.

FIG. 3 is a schematic configuration diagram illustrating a coating device.

FIG. 4 is a perspective view illustrating main components of the coating device according to a first embodiment.

FIG. 5 is a cross-sectional view illustrating main components of the coating device according to the first embodiment.

FIG. 6 is a cross-sectional view illustrating a modified example of the coating device according to the first embodiment.

FIG. 7 is a cross-sectional view illustrating a modified example of the coating device according to the first embodiment.

FIG. 8 is a cross-sectional view illustrating a modified example of the coating device according to the first embodiment.

FIG. 9 is a perspective view illustrating main components of the coating device according to a second embodiment.

FIG. 10 is a cross-sectional view illustrating main components of the coating device according to the second embodiment.

FIG. 11 is a cross-sectional view illustrating a modified example of the coating device according to the second embodiment.

FIG. 12 is a cross-sectional view illustrating a modified example of the coating device according to the second embodiment.

### DESCRIPTION OF THE PREFERRED EMBODIMENTS

Hereinafter, preferred embodiment of the present invention will be described with reference to the accompanying drawings.

<<Overall Configuration of Ink Jet Recording Apparatus>>

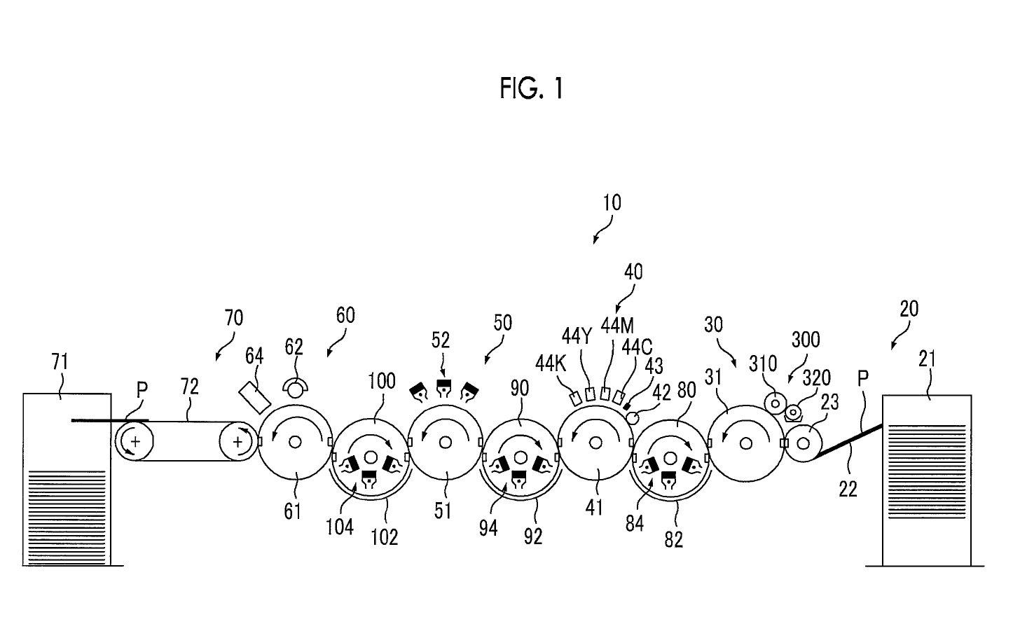

FIG. 1 is an overall configuration diagram illustrating an embodiment of an ink jet recording apparatus according to the present invention.

An ink jet recording apparatus 10 is an apparatus that performs printing on a sheet of paper P by an ink jet method using aqueous ink (ink including water in a solvent), and includes a paper feed unit 20 that feeds the paper P, a process liquid coating unit 30 that coats process liquid to the printing surface (surface) of the paper P, an image recording unit 40 that ejects ink drops of each color of cyan (C), magenta (M), yellow (Y), and black (K) to the printing surface of the paper P by an ink jet head, to draw a color image, an ink drying unit 50 that dries the ink drops ejected to the paper P, a fixing unit 60 that fixes the image recorded on the paper P, and a recovery unit 70 that recovers the paper P.

Each of the units of the process liquid coating unit 30, the image recording unit 40, the ink drying unit 50, and the fixing unit 60 is provided with transport drums 31, 41, 51, and 61, respectively, as transport unit of the paper P. The paper P is transported through each of the units of the process liquid coating unit 30, the image recording unit 40, the ink drying unit 50, and the fixing unit 60 by the transport drums 31, 41, 51, and 61.

Each of the transport drums 31, 41, 51, and 61 is formed in a cylindrical shape corresponding to the paper width, and is driven and rotated (rotated in the counterclockwise direction in FIG. 1) by a motor which is not shown. Grippers are included in the circumferential surface of each of the transport drums 31, 41, 51, and 61. The paper P is transported with the tip portion thereof gripped by the grippers. Meanwhile, in the present example, the grippers are installed at two places on the circumferential surface of each of the transport drums 31, 41, 51, and 61, and two sheets of paper can be transported in one rotation.

A large number of absorption holes are formed in the circumferential surface of each of the transport drums 31, 41, 51, and 61. The paper P is held on the outer circumferential surface of each of the transport drums 31, 41, 51, and 61 by vacuum adsorption of the back side thereof from the absorption holes. Meanwhile, although the paper P is held by vacuum adsorption in the present example, the paper P can also be held by electrostatic adsorption.

Transfer cylinders 80, 90, and 100 are disposed, respectively, between the process liquid coating unit 30 and the image recording unit 40, between the image recording unit 40 and the ink drying unit 50, and between the ink drying unit 50 and the fixing unit 60. The paper P is transported between each of the units by the transfer cylinders 80, 90, and 100.

Each of the transfer cylinders 80, 90, and 100 is formed by a cylindrical frame body corresponding to the paper width, and is driven and rotated (rotated in the clockwise direction in FIG. 1) by a motor which is not shown. Grippers are included in the circumferential surface of each of the transfer cylinders 80, 90, and 100. The paper P is transported with the tip portion thereof gripped by the grippers. Meanwhile, in the present example, the grippers are installed at two places on the outer circumferential portion of each of the transfer cylinders 80, 90, and 100, and two sheets of paper can be transported in one rotation.

In the lower portion of each of the transfer cylinders 80, 90, and 100, arc-like guide plates 82, 92, and 102 are arranged along a transport path of the paper P. The paper P transported by the transfer cylinders 80, 90, and 100 is transported while the back side thereof (surface on the opposite side of the printing surface) is guided to the guide plates 82, 92, and 102.

In addition, dryers 84, 94, and 104 that expel hot air toward the paper P transported by the transfer cylinder 80 are disposed in the inside of each of the transfer cylinders 80, 90, and 100 (in the present example, three dryers are disposed along the transport path of the paper P). The hot air expelled from the dryers 84, 94, and 104 in the transport process is blown against the printing surface of the paper P transported by each of the transfer cylinders 80, 90, and 100.

Meanwhile, instead of performing heating expelling hot air, the dryers 84, 94, and 104 may perform heating by emitting heat from an infrared heater or the like (so-called, heating by radiation).

The paper P fed from the paper feed unit 20 is transported in the order of the transport drum 31→the transfer cylinder 80→the transport drum 41÷the transfer cylinder 90→the transport drum 51→the transfer cylinder 100→the transport drum 61, and is finally recovered in the recovery unit 70. Necessary processing is performed on the paper P until the paper is recovered from the paper feed unit 20 to the recovery unit 70, and an image is recorded on the printing surface.

Hereinafter, the configuration of each of the units of the ink jet recording apparatus 10 according to the present embodiment will be described.

<Paper Feed Unit>

The paper feed unit 20 periodically feeds a sheet of the paper P one by one. The paper feed unit 20 is mainly constituted by a paper feed device 21, a paper feed tray 22, and a transfer cylinder 23.

The paper feed device 21 feeds the paper P stacked in a magazine, not shown, one by one to the paper feed tray 22 in order from the upper side.

The paper feed tray 22 sends out the paper P fed from the paper feed device 21 toward the transfer cylinder 23.

The transfer cylinder 23 receives and rotates the paper P sent out from the paper feed tray 22, and transfers the paper to the transport drum 31 of the process liquid coating unit 30.

Here, as the paper P used in the ink jet recording apparatus 10 according to the present embodiment, normal printing paper (which is not specialty ink jet paper, but paper (cellulose-based paper such as high-quality paper, coated paper, and art paper) used in normal offset printing and the like) is used.

When normal printing paper is printed using the ink jet method, bleeding and the like occur, and thus the image quality is damaged. Consequently, in order to prevent such a defect, the process liquid is coated to the paper P in the process liquid coating unit 30 below.

<Process Liquid Coating Unit>

The process liquid coating unit 30 coats the process liquid to the printing surface of the paper P. The process liquid coating unit 30 is mainly constituted by a transport drum (hereinafter, referred to as the “process liquid coating drum”) 31 that transports the paper P, and a coating device 32 that coats the process liquid to the printing surface of the paper P transported by the process liquid coating drum 31.

The process liquid coating drum 31 receives the paper P from the transfer cylinder 23 of the paper feed unit 20 (grips the tip of the paper P by the gripper and receives the paper), and transports the paper P along a predetermined transport path by rotation.

The coating device 32 coats the process liquid through the roller to the printing surface of the paper P transported by the process liquid coating drum 31. The configuration of the coating device 32 will be described later in detail.

The process liquid to be coated by the coating device 32 is formed of a liquid including a coagulant for coagulating components in the ink composition.

As a coagulant, compounds capable of changing the pH of the ink composition may be used, multivalent metal salts may be used, and polyallylamines may be used.

Compounds capable of lowering the pH suitably include acidic substances having a high water solubility (a phosphoric acid, an oxalic acid, a malonic acid, a citric acid, a derivative of the compounds thereof, or salts thereof, and the like). A single acidic substance may be used, and two kinds or more of acidic substances may be used together. Thereby, the coagulating property can be enhanced, and all the ink can be fixed.

In addition, it is preferable that pH (25° C.) of the ink composition is 8.0 or more, and pH (25° C.) of the process liquid is in the range of 0.5 to 4. Thereby, the image density, the resolution, and speeding up of ink jet recording can be achieved.

In addition, additive agents can be contained in the process liquid. For example, known additive agents such as an anti-drying agent (wetting agent), an anti-fading agent, an emulsion stabilizer, a penetration-enhancing agent, an ultraviolet absorbing agent, an antiseptic agent, a mildew-prevention agent, a pH adjusting agent, a surface tension adjusting agent, an antifoaming agent, a viscosity modifying agent, a dispersing agent, a dispersion stabilizer, a rust-preventive agent, and a chelating agent can be contained therein. Such a process liquid is coated to the printing surface of the paper P in advance and the printing is performed, whereby feathering, bleeding or the like can be prevented from being generated, and the high-quality printing can be performed even when normal printing paper is used.

In the process liquid coating unit 30 having such a configuration, the paper P is held in the process liquid coating drum 31, and is transported through a predetermined transport path. In the transport process, the process liquid is coated to the printing surface by the coating device 32.

The paper P of which the printing surface is coated with the process liquid is then transferred from the process liquid coating drum 31 to the transfer cylinder 80 at a predetermined position. The paper is transported through the predetermined transport path by the transfer cylinder 80, and is transferred to the transport drum 41 of the image recording unit 40.

Here, as mentioned above, the dryer 84 is installed in the inside of the transfer cylinder 80, and a hot air is expelled toward the guide plate 82. In the process where the paper P is transported from the process liquid coating unit 30 to the image recording unit 40 by the transfer cylinder 80, a hot air is blown against the printing surface, and the process liquid coated to the printing surface is dried (the solvent component in the process liquid is evaporated and removed).

<Image Recording Unit>

The image recording unit 40 ejects the ink drops of each color of C, M, Y, and K to the printing surface of the paper P, and draws a color image on the printing surface of the paper P. The image recording unit 40 is mainly constituted by the transport drum (hereinafter, referred to as the “image recording drum”) 41 that transports the paper P, a paper pressing roller 42 that presses the printing surface of the paper P to closely attach the back side of the paper P to the circumferential surface of the image recording drum 41, a paper floating detection sensor 43 that detects floating of the paper P, and ink jet heads 44C, 44M, 44Y, and 44K that eject the ink drops of each color of C, M, Y, and K to the paper P to draw an image.

The image recording drum 41 receives the paper P from the transfer cylinder 80 (grips the tip of the paper P by the gripper and receives the paper), and transports the paper P along a predetermined transport path by rotation.

The paper pressing roller 42 is formed by a rubber roller corresponding to the paper width, and is disposed in the vicinity of a paper receiving position (position for receiving the paper P from the transfer cylinder 80) of the image recording drum 41. The paper P transferred from the transfer cylinder 80 to the image recording drum 41 is nipped by the paper pressing roller 42, so that the back side thereof is closely attached to the outer circumferential surface of the image recording drum 41.

The paper floating detection sensor 43 detects floating of the paper P passing through the paper pressing roller 42 (detects floating above a certain level from the outer circumferential surface of the image recording drum 41). The paper floating detection sensor 43 is constituted by, for example, a laser projector and a laser photoreceiver. The laser projector projects laser light, which is parallel to the shaft of the image recording drum 41 from one end of the image recording drum 41 toward the other end thereof, from the outer circumferential surface of the image recording drum 41 to a position having a predetermined height. The laser photoreceiver is disposed opposite to the laser projector with the image recording drum 41 interposed therebetween, and receives the laser light projected from the laser projector. When floating above a certain level occurs in the paper P passing through the paper pressing roller 42, the laser light projected from the laser projector is blocked by the paper P, and is not received in the laser photoreceiver. The paper floating detection sensor 43 detects the presence or absence of the reception of the laser light in the laser photoreceiver, and detects floating of the paper P.

Four ink jet heads 44C, 44M, 44Y and 44K are disposed at the latter stage of the paper floating detection sensor 43, and are disposed along the transport path of the paper P at regular intervals. The ink jet heads 44C, 44M, 44Y, and 44K are formed by a line head corresponding to the paper width, and eject ink drops of the corresponding colors from the nozzle column formed on the nozzle surface toward the image recording drum 41.

Ink used in the ink jet recording apparatus 10 according to the present embodiment is aqueous ultraviolet-curable ink, and contains a water-soluble polymerizable compound polymerized by a pigment, polymer particles and active energy rays. The aqueous ultraviolet-curable ink can be hardened by ultraviolet irradiation, and has a property of the friction resistance being excellent and the film strength being high.

As the pigment, a water-dispersible pigment of which at least a portion of the surface is coated with a polymer dispersing agent is used.

As the polymer dispersing agent, a polymer dispersing agent of which the acid value is 25 to 1000 (KOHmg/g) is used. The self-dispersing stability is enhanced, and the coagulating property when the process liquid is brought into contact therewith is enhanced.

As the polymer particles, self-dispersing polymer particles of which the acid value is 20 to 50 (KOHmg/g) are used. The self-dispersing stability is enhanced, and the coagulating property when the process liquid is brought into contact therewith is enhanced.

As the polymerizable compound, a nonionic or cationic polymerizable compound is preferably used from the point of not interfering with the reaction with the coagulant, the pigment, and the polymer particles, and a polymerizable compound of which the solubility in water is 10 mass % or more (and further, 15 mass % or more) is preferably used.

In addition, ink contains an initiator for initiating polymerization of the polymerizable compound by active energy rays. As the initiator, a compound capable of initiating the polymerization reaction by active energy rays can be appropriately selected and contained, and, for example, an initiator (for example, a photopolymerization initiator or the like) for generating active species (a radical, an acid, a base or the like) by radiation, light or an electron beam can be used. Meanwhile, the initiator can be contained in the process liquid, and is preferably contained in at least one of the ink or the process liquid.

In addition, the ink contains water of 50 to 70 mass %. In addition, an additive agent can be contained in the ink. For example, known additive agents such as a water-soluble organic solvent or an anti-drying agent (wetting agent), an anti-fading agent, an emulsion stabilizer, a penetration-enhancing agent, an ultraviolet absorbing agent, an antiseptic agent, a mildew-prevention agent, a pH adjusting agent, a surface tension adjusting agent, an antifoaming agent, a viscosity modifying agent, a dispersing agent, a dispersion stabilizer, a rust-preventive agent, and a chelating agent can be contained therein.

In the image recording unit 40 having the above-mentioned configuration, the paper P is transported through a predetermined transport path by the image recording drum 41. The paper P transferred from the transfer cylinder 80 to the image recording drum 41 is first nipped in the paper pressing roller 42, and is closely attached to the outer circumferential surface of the image recording drum 41. Next, the presence or absence of the floating is detected by the paper floating detection sensor 43, and then the ink drops of each color of C, M, Y, and K are ejected from each of the ink jet heads 44C, 44M, 44Y, and 44K to the printing surface, and the color image is drawn on the printing surface.

Meanwhile, when the floating of the paper P is detected, the transport is stopped. Thereby, the floated paper P can be prevented from being brought into contact with the nozzle surfaces of the ink jet heads 44C, 44M, 44Y, and 44K.

As mentioned above, in the ink jet recording apparatus 10 of the present example, aqueous ink is used in all each color. Even when such aqueous ink is used, the process liquid is coated to the paper P as mentioned above. Therefore, even when normal printing paper is used, high-quality printing can be performed.

The paper P on which the image is drawn is transferred to the transfer cylinder 90. The paper is transported through a predetermined transport path by the transfer cylinder 90, and is transferred to the transport drum 51 of the ink drying unit 50.

Here, as mentioned above, the dryer 94 is installed in the inside of the transfer cylinder 90, and hot air is expelled toward the guide plate 92. Although drying of ink is performed in the ink drying unit 50 of the subsequent stage, drying of the paper P is also performed at the time of the transport by the transfer cylinder 90.

Meanwhile, the image recording unit 40 is provided with a maintenance unit, not shown, that performs maintenance of the ink jet heads 44C, 44M, 44Y, and 44K, and the ink jet heads 44C, 44M, 44Y and 44K move to the maintenance unit as necessary, thereby allowing required maintenance to be performed.

<Ink Drying Unit>

The ink drying unit 50 dries the liquid component remaining in the paper P after image recording. The ink drying unit 50 is mainly constituted by the transport drum (hereinafter, referred to as the “ink drying drum”) 51 that transports the paper P, and an ink drying device 52 that performs drying on the paper P transported by the ink drying drum 51.

The ink drying drum 51 receives the paper P from the transfer cylinder 90 (grips the tip of the paper P by the gripper and receives the paper), and transports the paper P along a predetermined transport path by rotation.

The ink drying device 52 is formed by, for example, a dryer (formed by three dryers arranged along the transport path of the paper P in the present example), and blows off hot air (for example, 80° C.) toward the paper P transported by the ink drying drum 51.

In the ink drying unit 50 having the above-mentioned configuration, the paper P is transported through a predetermined transport path by the ink drying drum 51. In the transport process, hot air is blown off from the ink drying device 52 to the printing surface, and the ink supplied to the printing surface is dried (the solvent component is evaporated and removed).

The paper P passing through the ink drying device 52 is then transferred from the ink drying drum 51 to the transfer cylinder 100 in a predetermined position. The paper is transported through a predetermined transport path by the transfer cylinder 100, and is transferred to the transport drum 61 of the fixing unit 60.

Meanwhile, as mentioned above, the dryer 104 is installed in the inside of the transfer cylinder 100, and hot air is expelled toward the guide plate 102. Therefore, the drying of the paper P is also performed at the time of the transport in the transfer cylinder 100.

<Fixing Unit>

The fixing unit 60 heats and pressurizes the paper P, and fixes the image recorded on the printing surface. The fixing unit 60 is mainly constituted by the transport drum (hereinafter, referred to as the “fixing drum”) 61 that transports the paper P, an ultraviolet irradiation light source 62 that exposes the printing surface of the paper P to ultraviolet rays, and an inline sensor 64 that detects the temperature, the humidity and the like of the paper P after printing and captures the printed image.

The fixing drum 61 receives the paper P from the transfer cylinder 100 (grips the tip of the paper P by the gripper and receives the paper), and transports the paper P along a predetermined transport path by rotation.

The ultraviolet irradiation light source 62 performs ultraviolet irradiation on the printing surface of the paper P transported by the fixing drum 61, and solidifies a coagulated body of the process liquid and the ink.

The inline sensor 64 includes a thermometer, a hygrometer, a CCD line sensor and the like, detects the temperature, the humidity and the like of the paper P transported by the fixing drum 61, and reads out the image printed on the paper P. The abnormality of the device, the defective ejection of the head and the like are checked based on the detection result of the inline sensor 64.

In the fixing unit 60 having the above-mentioned configuration, the paper P is transported through a predetermined transport path by the fixing drum 61. In the transport process, the ultraviolet irradiation is performed from the ultraviolet irradiation light source 62 to the printing surface, and the coagulated body of the process liquid and the ink is solidified.

The paper P on which the fixing is performed is then transferred from the fixing drum 61 to the recovery unit 70 in a predetermined position.

<Recovery Unit>

The recovery unit 70 is configured so that the paper P on which a series of printing processes are performed is stacked with a stacker 71 and is recovered. The recovery unit 70 is mainly constituted by the stacker 71 that recovers the paper P, and a paper discharge conveyor 72 that receives the paper P fixed by the fixing unit 60 from the fixing drum 61, transports the paper through a predetermined transport path, and discharges it to the stacker 71.

The paper P fixed by the fixing unit 60 is transferred from the fixing drum 61 to the paper discharge conveyor 72, transported to the stacker 71 by the paper discharge conveyor 72, and recovered within the stacker 71.

<<Control System>>

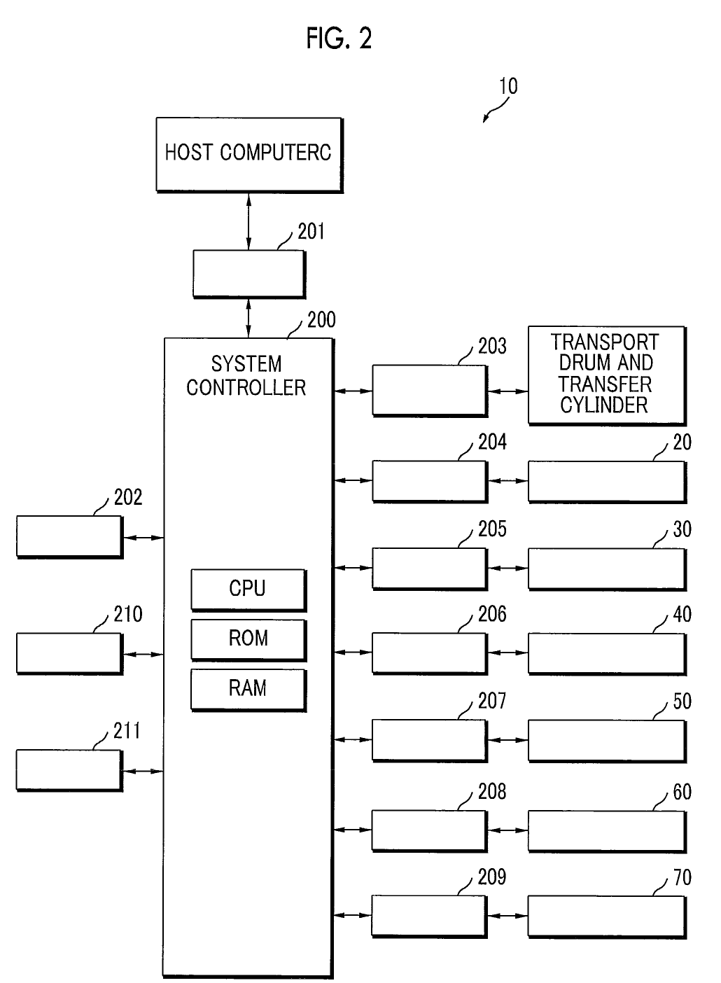

FIG. 2 is a block diagram illustrating a schematic configuration of a control system of the ink jet recording apparatus 10 according to the present embodiment.

As shown in the same drawing, the ink jet recording apparatus 10 includes a system controller 200, a communication unit 201, an image memory 202, a transport control unit 203, a paper feed control unit 204, a process liquid coating control unit 205, an image recording control unit 206, an ink drying control unit 207, a fixing control unit 208, a recovery control unit 209, an operation unit 210, a display unit 211, and the like.

The system controller 200 functions as control unit for overall controlling each of the units of the ink jet recording apparatus 10, and functions as arithmetic means for performing various types of arithmetic operations. The system controller 200 includes a CPU, a ROM, a RAM and the like, and operates in accordance with a predetermined control program. Control programs executed by the system controller 200 or various types of data necessary for the control are stored in the ROM.

The communication unit 201 includes a necessary communication interface, and transmits and receives data to and from a host computer connected to the communication interface.

The image memory 202 functions as temporary storage unit of various types of data including image data, and reading and writing of data are performed through the system controller 200. The image data taken from the host computer through the communication unit 201 are stored in the image memory 202.

The transport control unit 203 controls the driving of the transport drums 31, 41, 51, and 61 which are transport unit of the paper Pin each of the units of the process liquid coating unit 30, the image recording unit 40, the ink drying unit 50, and the fixing unit 60, and the driving of the transfer cylinders 80, 90, and 100.

That is, the driving of a motor that drive each of the transport drums 31, 41, 51, and 61 is controlled, and the opening and closing of the gripper included in each of the transport drums 31, 41, 51, and 61 are controlled.

Similarly, the driving of a motor that drive each of the transfer cylinders 80, 90, and 100 is controlled, and the opening and closing of the gripper included in each of the transfer cylinders 80, 90, and 100 are controlled.

In addition, since each of the transport drums 31, 41, 51, and 61 is provided with a mechanism that adsorptively holds the paper P on the circumferential surface, the driving of the adsorptive holding mechanism is controlled (in the present embodiment, since the paper P is vacuum adsorbed, the driving of a vacuum pump serving as negative pressure generating unit is controlled).

In addition, since each of the transfer cylinders 80, 90, and 100 is provided with the dryers 84, 94, and 104, the driving thereof (the heating amount and the blowing amount) is controlled.

The driving of the transport drums 31, 41, 51, and 61, and the transfer cylinders 80, 90, and 100 is controlled according to a command from the system controller 200.

The paper feed control unit 204 controls the driving of each of the units (the paper feed device 21, the transfer cylinder 23 and the like) constituting the paper feed unit 20 according to a command from the system controller 200.

The process liquid coating control unit 205 controls the driving of each of the units (the coating device 32 and the like) constituting the process liquid coating unit 30 according to a command from the system controller 200.

The image recording control unit 206 controls the driving of each of the units (the paper pressing roller 42, the ink jet heads 44C, 44M, 44Y, and 44K, and the like) constituting the image recording unit 40 according to a command from the system controller 200.

The ink drying control unit 207 controls the driving of each of the units (the ink drying device 52 and the like) constituting the ink drying unit 50 according to a command from the system controller 200.

The fixing control unit 208 control the driving of each of the units (the ultraviolet irradiation light source 62, the inline sensor 64 and the like) constituting the fixing unit 60 according to a command from the system controller 200.

The recovery control unit 209 controls the driving of each of the units (the paper discharge conveyor 72 and the like) constituting the recovery unit 70 according to a command from the system controller 200.

The operation unit 210 includes necessary operation unit (for example, operation buttons, a keyboard, a touch panel and the like), and outputs operation information, which is input from the operation unit, to the system controller 200. The system controller 200 executes various types of processes according to the operation information which is input from the operation unit 210.

The display unit 211 includes a necessary display device (for example, an LCD panel and the like), and displays necessary information on the display device according to a command from the system controller 200.

As mentioned above, the image data recorded on the paper are incorporated into the ink jet recording apparatus 10 from the host computer through the communication unit 201, and are stored in the image memory 202. The system controller 200 performs necessary signal processing on the image data stored in the image memory 202 to generate dot data, and controls the driving of each ink jet head of the image recording unit 40 according to the generated dot data, to thereby record an image represented by the image data on the paper.

The dot data are generated generally by performing color conversion processing and half-tone processing image data. The color conversion processing is a process of converting image data (for example, image data of RB8 bit) represented by sRB and the like into data of the ink amount of each color of ink used in the ink jet recording apparatus 10 (in the present example, converted into data of the ink amount of each color of C, M, Y, and K). The half-tone processing is a process of converting the data of the ink amount of each color generated by the color conversion processing into dot data of each color using a process such as error diffusion.

The system controller 200 generates the dot data of each color by performing the color conversion processing and the half-tone processing on the image data. The image represented by the image data is recorded on the paper by controlling the driving of the corresponding ink jet head according to the generated dot data of each color.

<<Printing Operation>>

Next, an outline will be given of a printing operation using the above-mentioned ink jet recording apparatus 10.

When a paper feed command is output from the system controller 200 to the paper feed device 21, the paper P is fed from the paper feed device 21 to the paper feed tray 22. The paper P fed to the paper feed tray 22 is transferred to the process liquid coating drum 31 of the process liquid coating unit 30 through the transfer cylinder 23.

The paper P transferred to the process liquid coating drum 31 is transported through a predetermined transport path by the process liquid coating drum 31, and in the transport process, the process liquid is coated to the printing surface by the coating device 32.

The paper P to which the process liquid is coated is transferred from the process liquid coating drum 31 to the transfer cylinder 80. The paper is transported through a predetermined transport path by the transfer cylinder 80, and is transferred to the image recording drum 41 of the image recording unit 40. In the transport process by the transfer cylinder 80 a hot air is blown off on the paper P from the dryer 84 installed in the inside of the transfer cylinder 80 to the printing surface, and the process liquid coated to the printing surface is dried.

The paper P transferred from the transfer cylinder 80 to the image recording drum 41 is first nipped by the paper pressing roller 42, and the back side thereof is closely attached to the outer circumferential surface of the image recording drum 41.

The presence or absence of the floating of the paper P passing through the paper pressing roller 42 is then detected by the paper floating detection sensor 43. Here, when the floating of the paper P is detected, the transport thereof is stopped. On the other hand, when the floating thereof is not detected, the paper is transported toward the ink jet heads 44C, 44M, 44Y, and 44K as it is. When the paper passes under each of the ink jet heads 44C, 44M, 44Y, and 44K, the ink drops of each color of C, M, Y, and K are ejected from each of the ink jet heads 44C, 44M, 44Y, and 44K, and the color image is drawn on the printing surface.

The paper P on which the image is drawn is transferred from the image recording drum 41 to the transfer cylinder 90. The paper is transported through a predetermined transport path by the transfer cylinder 90, and is transferred to the ink drying drum 51 of the ink drying unit 50. In the transport process by the transfer cylinder 90, a hot air is blown off on the paper P from the dryer 94 installed in the inside of the transfer cylinder 90 to the printing surface, and the ink supplied to the printing surface is dried.

The paper P transferred to the ink drying drum 51 is transported through a predetermined transport path by the ink drying drum 51. In the transport process, hot air is blown off on the printing surface from the ink drying device 52, and the liquid component remaining in the printing surface is dried.

The dried paper P is transferred from the ink drying drum 51 to the transfer cylinder 100. The paper is transported through a predetermined transport path by the transfer cylinder 100, and is transferred to the fixing drum 61 of the fixing unit 60. In the transport process by the transfer cylinder 100, a hot air is blown off on the paper P from the dryer 104 installed in the inside of the transfer cylinder 100 to the printing surface, and the ink supplied to the printing surface is further dried.

The paper P transferred to the fixing drum 61 is transported through a predetermined transport path by the fixing drum 61. In the transport process, ultraviolet irradiation is performed on the printing surface, and the drawn image is fixed on the paper P. The paper P is then transferred from the fixing drum 61 to the paper discharge conveyor 72 of the recovery unit 70, transported to the stacker 71 by the paper discharge conveyor 72, and discharged into the stacker 71.

As described above, in the ink jet recording apparatus 10 of the present example, the paper P is transported by the drum, and on the transport process, each process of coating of the process liquid, drying, ejection of the ink drops, drying, and fixing is performed on the paper P, to thereby record a predetermined image on the paper P.

### Coating Device

### First Embodiment

### Configuration

As mentioned above, the coating device 32 coats the process liquid to the printing surface of the paper P by the roller.

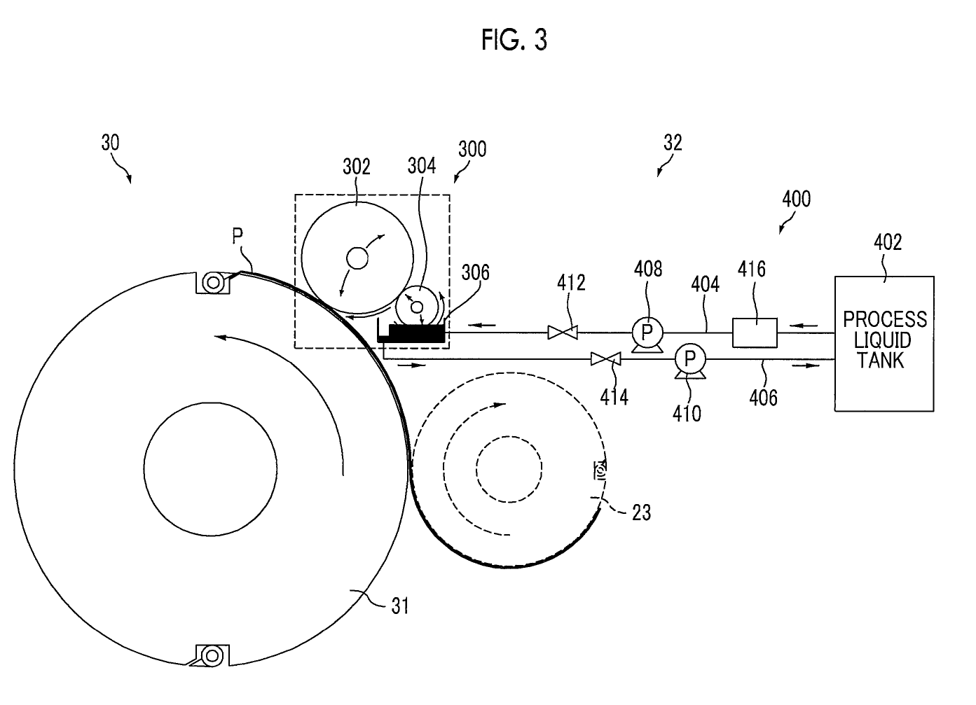

FIG. 3 is a schematic configuration diagram illustrating the coating device. As shown in the same drawing, the coating device 32 is mainly constituted by a coating unit 300 for coating the process liquid to the paper P by the roller, and a process liquid supply unit 400 for circulating and supplying the process liquid to the coating unit 300.

-Coating Unit-

The coating unit 300 is mainly constituted by a coating roller 302, a drawing-up roller 304, and a process liquid vessel 306, and is installed on the transport path of the paper P transported by the process liquid coating drum 31.

The coating roller 302 is formed to have substantially the same width (axial length) as that of the process liquid coating drum 31, and is rotatably supported on the tip portion of a pair of coating roller support arms (not shown) of which both ends are included in the body frame (not shown) of the coating unit 300. The coating roller support arms are swingably provided around the rotary shaft of the drawing-up roller 304 located at a predetermined providing position, and are driven and swung by a coating roller swinging actuator (not shown; for example, a cylinder or the like). The coating roller 302 moves between a predetermined coating position and a retraction position by swinging the coating roller support arms.

The coating roller 302 is disposed parallel to the process liquid coating drum 31, and is pressed and brought into contact with the outer circumferential surface of the process liquid coating drum 31 by moving to the coating position. In addition, the coating roller is separated from the outer circumferential surface of the process liquid coating drum 31 by moving to the retraction position.

In addition, the coating roller support arm is provided with a coating roller rotating actuator (not shown; for example, a motor). The coating roller 302 is driven by the coating roller rotating actuator and rotates at a predetermined rotational speed (rotates in the direction opposite to the rotational direction of the process liquid coating drum 31).

Meanwhile, the coating roller rotating actuator is provided with a one-way clutch, and when the coating roller 302 is pressed and brought into contact with the process liquid coating drum 31, it is configured to be capable of absorbing the speed difference.

The drawing-up roller 304 is formed to have substantially the same width (axial length) as that of the coating roller 302, and is rotatably supported on the tip portion of a pair of drawing-up roller support arms (not shown) of which both ends are included in the body frame (not shown) of the coating unit 300. The drawing-up roller support arms are swingably provided in the body frame, and are driven and swung by a drawing-up roller swinging actuator (not shown; for example, a cylinder or the like). The drawing-up roller 304 moves between a predetermined providing position and a separation position by swinging the drawing-up roller support arms.

The drawing-up roller 304 is disposed parallel to the coating roller 302, and is pressed and brought into contact with the outer circumferential surface of the coating roller 302 by moving to the providing position. In addition, the drawing-up roller is separated from the outer circumferential surface of the coating roller 302 by moving to the separation position.

In addition, the drawing-up roller support arm is provided with a drawing-up roller rotating actuator (not shown). The drawing-up roller 304 is driven by the drawing-up roller rotating actuator (not shown; for example, a motor) and rotates at a predetermined rotational speed (rotates in the direction opposite to the rotational direction of the process liquid coating drum 31).

Meanwhile, the drawing-up roller rotating actuator is provided with a one-way clutch, and when the drawing-up roller 304 is pressed and brought into contact with the coating roller 302, it is configured to be capable of absorbing the speed difference.

The process liquid vessel 306 is formed in a rectangular dish shape, and the process liquid is reserved in the inside thereof. A portion of (lower portion) of the drawing-up roller 304 is immersed in the process liquid vessel 306. That is, the drawing-up roller 304 draws up the process liquid reserved in the process liquid vessel 306, and supplies the process liquid to the coating roller 302. Therefore, the process liquid vessel 306 is formed corresponding to the drawing-up roller 304, and is formed to have an opening area (area of the portion in which the upper portion is opened) and a depth capable of immersing a portion of the drawing-up roller 304.

Here, when the opening area of the process liquid vessel 306 is excessively large compared to the immersed portion (portion immersed in the process liquid) of the drawing-up roller 304, the evaporation amount of the process liquid increases at that rate, and the decrease in the process liquid becomes rapid. Therefore, the opening area thereof is preferably made as small as possible.

In addition, in order to stably supply the process liquid, it is preferable that the liquid level of the reserved process liquid is always constant.

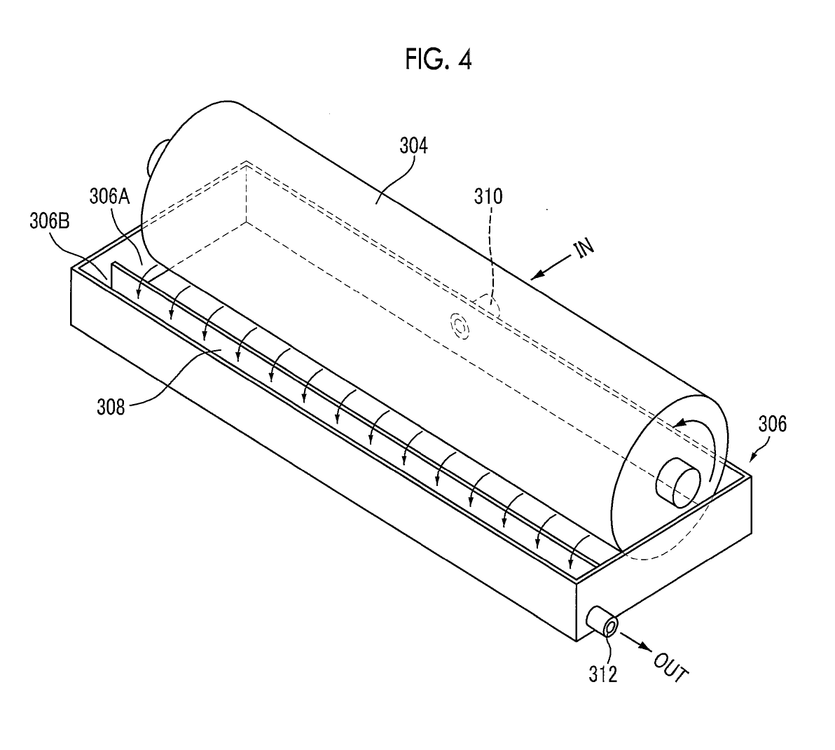

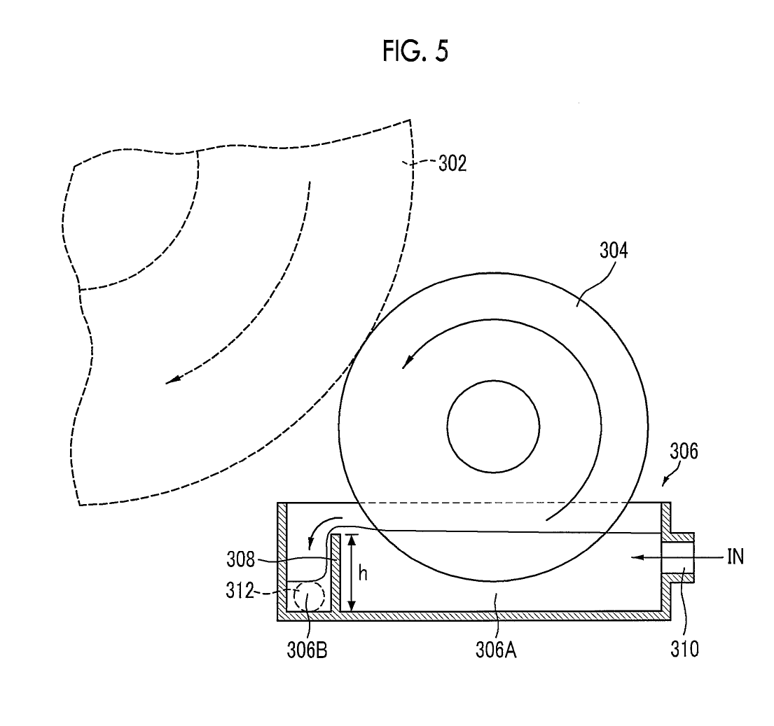

Consequently, as shown in FIGS. 4 and 5, the process liquid vessel 306 of the present embodiment is configured such that the inside of the process liquid vessel 306 is divided into a portion (portion in which the drawing-up roller 304 is immersed) for reserving the process liquid and a portion for recovering the process liquid by providing a partition plate 308 in the inside thereof, and the liquid level of the portion for reserving the process liquid is maintained constant while suppressing the opening area. Specifically, the process liquid vessel is configured as follows.

As shown in FIGS. 4 and 5, the process liquid vessel 306 is formed lengthwise in the width direction and in a rectangular dish shape of which the upper portion is opened, corresponding to the drawing-up roller 304.

In the inside of the process liquid vessel 306, the partition plate 308 is installed along the longitudinal direction of the process liquid vessel 306 (axial direction of the drawing-up roller 304). The partition plate 308 is disposed upright vertically from the bottom of the process liquid vessel 306, and the height h thereof (height from the bottom of the process liquid vessel 306) is formed lower than the height of the wall surface constituting the outer circumferential wall of the process liquid vessel 306. The inside of the process liquid vessel 306 is divided into two parts, a reservoir 306A and a recovery chamber 306B, by the partition plate 308.

The reservoir 306A is a region for reserving the process liquid supplied to the drawing-up roller 304, that is, a region in which the drawing-up roller 304 is immersed, and the opening area thereof is formed to have a size capable of receiving the immersed portion (portion immersed in the reserved process liquid) of the drawing-up roller 304. Specifically, when the immersed portion of the drawing-up roller 304 is received, the reservoir is formed to have a size capable of forming a predetermined gap in the periphery of the immersed portion. This gap is preferably as small as possible, from the viewpoint of preventing the reserved process liquid from being evaporated.

On the other hand, the recovery chamber 306B is a region for recovering the process liquid overflowing from the reservoir 306A beyond the partition plate 308, and the opening area thereof is formed to have a recoverable size without causing the process liquid overflowing from the reservoir 306A to leak out.

That is, the process liquid vessel 306 of the present example is configured such that the liquid level of the process liquid reserved in the reservoir 306A is maintained constant by always causing the process liquid reserved in the reservoir 306A to overflow from the partition plate 308.

Therefore, the liquid level of the process liquid reserved in the reservoir 306A is defined by the height of the partition plate 308.

The recovery chamber 306B is formed so as to be capable of recovering the overflowing process liquid without causing it to leak out. However, when the opening area thereof increases, the evaporation amount increases at that rate. Therefore, the recovery chamber 306B is preferably formed so that the opening area thereof becomes as small as possible. Therefore, the opening area of the recovery chamber 306B is formed smaller than the opening area of the reservoir 306A.

In this manner, the process liquid vessel 306 maintains the liquid level of the process liquid reserved in the reservoir 306A constant by causing the process liquid reserved in the reservoir 306A to overflow from the partition plate 308. For this reason, a supply port 310 for supplying the process liquid is formed in the reservoir 306A, and a recovery port 312 for discharge the recovered process liquid is formed in the recovery chamber 306B.

The supply port 310 of the process liquid is formed on the wall surface in the longitudinal direction (width direction) which constitutes the outer circumferential wall surface of the process liquid vessel 306, and is formed in the substantially central position (central position in the longitudinal direction) of the wall surface. In this manner, the process liquid can be uniformly and stably supplied to the reservoir 306A by forming the supply port 310 in the substantially central position of the wall surface in the longitudinal direction.

On the other hand, the recovery port 312 of the process liquid is formed on the wall surface in the lateral direction which constitutes the outer circumferential wall surface of the process liquid vessel 306.

According to the process liquid vessel 306 having such a configuration, the liquid level of the process liquid reserved in the reservoir 306A can be always maintained constant by supplying the process liquid so as to always overflow to the reservoir 306A.

The process liquid vessel 306 is formed so that the bottom thereof is parallel to the shaft of the drawing-up roller 304, and is horizontally attached to the body frame (not shown) of the coating unit 300.

At this time, the drawing-up roller 304 located at a predetermined providing position is attached by position adjustment so as to be disposed in the inner side of the reservoir 306A. In addition, the drawing-up roller 304 located at a predetermined providing position is attached by height adjustment so as to be immersed in the process liquid reserved in the reservoir 306A by the predetermined amount. Thereby, a portion of the drawing-up roller 304 can be immersed in the process liquid reserved in the reservoir 306A by the predetermined amount.

—Process Liquid Supply Unit—

As shown in FIG. 3, the process liquid supply unit 400 is mainly constituted by a process liquid tank 402, a process liquid supply tube 404, a process liquid recovery tube 406, a process liquid supply pump 408, a process liquid recovery pump 410, a process liquid supply valve 412, a process liquid recovery valve 414, a temperature regulation unit 416, and a temperature sensor (not shown).

The process liquid tank 402 is a tank having a constant volume in which the process liquid is reserved, and is provided with a process liquid supply port (not shown) and a process liquid recovery port (not shown).

The process liquid supply tube 404 is a tube for supplying the process liquid from the process liquid tank 402 to the process liquid vessel 306, and is configured such that one end thereof is connected to the process liquid supply port of the process liquid tank 402 and the other end thereof is connected to supply port 310 of the process liquid vessel 306.

The process liquid recovery tube 406 is a tube for returning the process liquid from the process liquid vessel 306 to the process liquid tank 402, and is configured such that one end thereof is connected to the process liquid recovery port of the process liquid tank 402 and the other end thereof is connected to the recovery port 312 of the process liquid vessel 306.

The process liquid supply pump 408 is a pump for sending the process liquid from the process liquid tank 402 through the process liquid supply tube 404 to the process liquid vessel 306, and is installed in the midway of the process liquid supply tube 404.

The process liquid recovery pump 410 is a pump for sending the process liquid from the process liquid vessel 306 through the process liquid recovery tube 406 to the process liquid tank 402, and is installed in the midway of the process liquid recovery tube 406.

The process liquid supply valve 412 is formed by a magnetic valve, and is installed in the midway of the process liquid supply tube 404 to open and close the tube line.

The process liquid recovery valve 414 is formed by a magnetic valve, and is installed in the midway of the process liquid recovery tube 406 to open and close the tube line.

The temperature regulation unit 416 is a unit for regulating the temperature of the process liquid supplied from the process liquid tank 402 through the process liquid supply tube 404 to the process liquid vessel 306 to a predetermined temperature, and is installed in the midway of the process liquid supply tube 404.

The temperature sensor (not shown) is installed in the reservoir 306A of the process liquid vessel 306, and detects the temperature of the process liquid reserved in the reservoir 306A. Detected temperature information of the process liquid is output to the system controller 200.

The driving of the process liquid supply pump 408, the process liquid recovery pump 410, the process liquid supply valve 412, the process liquid recovery valve 414, and the temperature regulation unit 416 is controlled by the system controller 200 through the process liquid coating control unit 205.

The system controller 200 executes a predetermined control program, controls the driving of the process liquid supply pump 408, the process liquid recovery pump 410, the process liquid supply valve 412, and the process liquid recovery valve 414, and circulates and supplies the process liquid to the process liquid vessel 306. In addition, the temperature of the process liquid reserved in the reservoir 306A is controlled to a constant temperature by executing the predetermined control program, controlling the driving of the temperature regulation unit 416, and controlling the temperature of the process liquid supplied to the process liquid vessel 306.

[Operation]

An operation of the coating device of the present embodiment having such a configuration is as follows.

First, the process liquid is supplied to the process liquid vessel 306. The supply of the process liquid is performed by opening the process liquid supply valve 412 and the process liquid recovery valve 414, and driving the process liquid supply pump 408 and the process liquid recovery pump 410. Thereby, the process liquid is circulated and supplied to the process liquid vessel 306. The temperature of the process liquid circulated and supplied to the process liquid vessel 306 is adjusted to a predetermined temperature by the temperature regulation unit 416.

In the process liquid vessel 306, the process liquid is supplied from the supply port 310, so that the process liquid is reserved in the reservoir 306A. The process liquid is circulated and supplied, and thus the process liquid reserved in the reservoir 306A overflows from the partition plate 308 when the liquid level thereof reaches the height of the partition plate 308. The overflowing process liquid is recovered in the recovery chamber 306B, and is returned from the recovery port 312 through the process liquid recovery tube 406 to the process liquid tank 402.

In this manner, the process liquid is circulated and supplied to the process liquid vessel 306, so that the process liquid is overflows in the inside of the process liquid vessel 306, and the liquid level of the reserved process liquid is maintained constant.

When a certain amount of the process liquid is reserved in the reservoir 306A of the process liquid vessel 306, a portion of (lower portion) of the drawing-up roller 304 is immersed in the process liquid reserved in the reservoir 306A. When the drawing-up roller 304 is rotated in this state, the process liquid is supplied to the circumferential surface of the drawing-up roller 304.

The coating of the process liquid to the paper P is performed as follows.

In an initial state, the coating roller 302 is located at a standby position, and the drawing-up roller 304 is located at a separation position.

First, the coating roller 302 and the drawing-up roller 304 are rotated. The process liquid is supplied to the circumferential surface of the drawing-up roller 304 by rotating the drawing-up roller 304.

Next, the drawing-up roller 304 is moved to a providing position, and the drawing-up roller 304 is brought into contact with the coating roller 302. Thereby, the process liquid supplied to the circumferential surface of the drawing-up roller 304 is transferred to the circumferential surface of the coating roller 302, and the process liquid is supplied to the circumferential surface of the coating roller 302.

The coating roller 302 moves from the retraction position to the coating position in time with the pass timing of the paper P. Thereby, the coating roller 302 is pressed and brought into contact with the printing surface of the paper P transported to the process liquid coating drum 31, and the process liquid is coated to the printing surface of the paper P.

When the process liquid is coated to a desired region, the coating roller 302 moves to the retraction position.

Thereby, the process liquid is coated to the paper P transported to the process liquid coating drum 31.

As described above, the coating device of the present embodiment can circulate and supply the process liquid to the process liquid vessel 306. Thereby, the process liquid can be prevented from being deteriorated, the liquid concentration can also be maintained constant, and the process liquid can be coated in a good state.

In addition, the coating device of the present embodiment can always maintain the liquid level of the process liquid constant which is circulated and supplied, and thus can stably coat the process liquid without unevenness. Particularly, in the aqueous ink jet printing in which normal printing paper is used, since it is required to extremely thinly coat the process liquid (appropriately 2 μm), it is important to be capable of stably coating the process liquid without unevenness.

In addition, in the coating device of the present embodiment, since the opening area of the process liquid vessel 306 is suppressed to a small degree, the evaporation of the process liquid from the process liquid vessel 306 can be effectively suppressed. In addition, thereby, not only the control of the liquid concentration can be easily performed, but also the temperature control can be easily performed.

Meanwhile, in the above-mentioned embodiment, although the partition plate 308 is disposed along the longitudinal direction of the process liquid vessel 306, the way to install the partition plate 308 is not limited thereto. The partition plate may be disposed in the direction perpendicular to the longitudinal direction. Meanwhile, as in the above-mentioned embodiment, the partition plate 308 is disposed along the longitudinal direction of the process liquid vessel 306, so that the process liquid can be caused to uniformly overflow along the longitudinal direction, and the liquid level of the process liquid reserved in the reservoir 306A can be further stabilized.

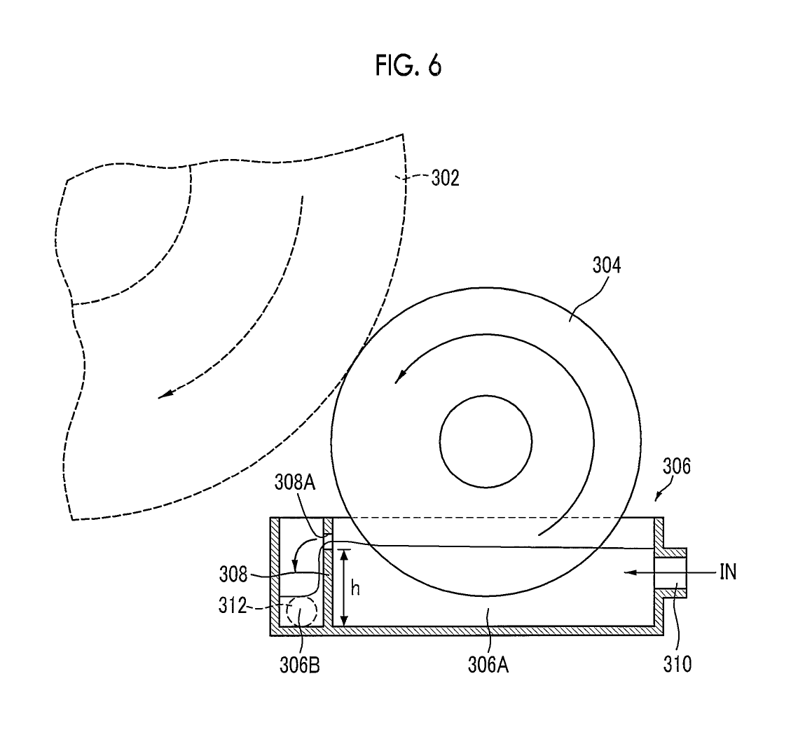

In addition, in the above-mentioned embodiment, although the process liquid is caused to overflow from the upper edge of the partition plate 308, as shown in FIG. 6, a hole 308A is formed at a position having a height causing the process liquid to overflow, and thus the process liquid may be caused to overflow from the hole 308A. For example, a hole is formed at a position having a height causing the process liquid to overflow, with a constant pitch along the longitudinal direction, and thus the process liquid may be caused to overflow from this hole. Alternatively, a slit-like hole is formed at a position having a height causing the process liquid to overflow, along the longitudinal direction, and thus the process liquid may be caused to overflow from this hole. Meanwhile, the height h of the partition plate 308 in this case is indicative of the height from the bottom of the process liquid vessel 306 to the hole 308A.

In addition, in the above-mentioned embodiment, although the partition plate 308 is fixed, the partition plate 308 can be exchanged, and the height thereof can be adjusted.

In addition, in the above-mentioned embodiment, although the supply port 310 is formed in the outer circumferential wall surface of the process liquid vessel 306, the position in which the supply port 310 is formed or installed is not limited thereto.

Meanwhile, there may be a case in which foam is generated in the process liquid vessel 306 with the supply of the process liquid. When the foam is attached to the coating roller 302, coating unevenness is caused.

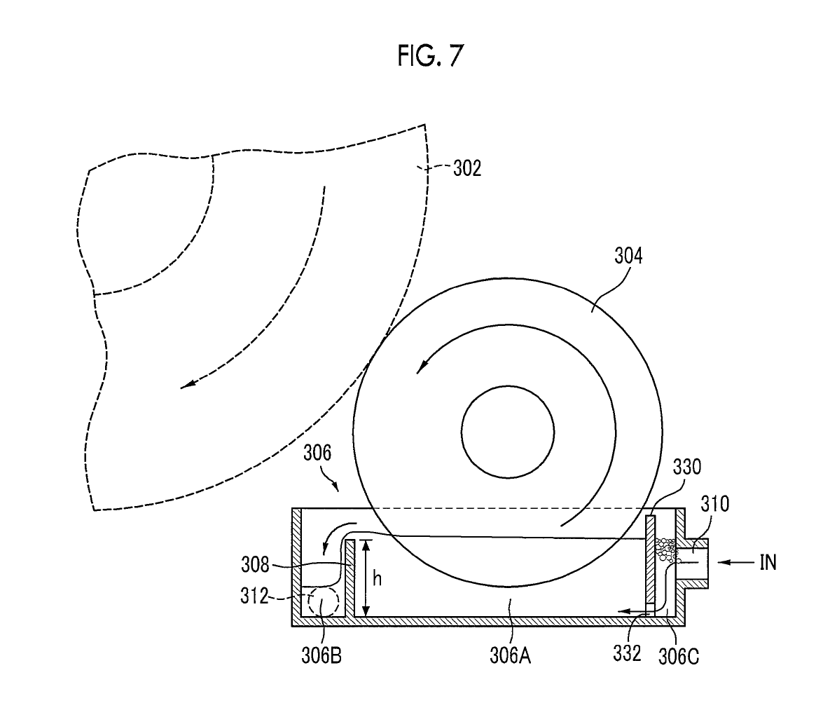

Consequently, as shown in FIG. 7, it is preferable that a shielding plate 330 is installed in the inside of the process liquid vessel 306, and the foam is prevented from being attached to the coating roller 302 due to the flow of the process liquid supplied from the supply port 310.

In an example shown in FIG. 7, the shielding plate 330 is provided parallel to the outer circumferential wall surface in which the supply port 310 is formed, and is provided upright vertically from the bottom of the process liquid vessel 306. In addition, the shielding plate is provided so that the upper end thereof protrudes from the liquid level of the process liquid reserved in the reservoir 306A by a predetermined amount.

In the shielding plate 330 installed in this manner, a buffer area 306C is formed at the preceding stage of the reservoir 306A. a communicating port 332 is formed in a lower position of the shielding plate 330, and the reservoir 306A and the buffer area 306C communicate with each other through the communicating port 332.

According to the process liquid vessel having such a configuration, the process liquid supplied from the supply port 310 is supplied from the communicating port 332 formed in the lower portion of the shielding plate 330 through the buffer area 306C to the reservoir 306A. The shielding plate 330 protrudes from the liquid level. Therefore, even when foam is generated by the supply of the process liquid, the foam can be prevented from flowing toward the coating roller 302. Thereby, the process liquid can be coated more stably.

Meanwhile, in the above-mentioned example, although the shielding plate 330 is integrally formed in the process liquid vessel, the shielding plate may be configured to be capable of being attached and detached, and may be configured so that the height thereof can be adjusted.

In addition, the shape of the communicating port 332 formed in the shielding plate 330 is not particularly limited, but may be a slit-like opening.

In addition, the shielding plate 330 is installed by floating from the bottom of the process liquid vessel 306 by a predetermined amount, so that the communicating port 332 may be formed.

Meanwhile, although the process liquid to be used is not particularly limited, there is a concern that the process liquid shows strong acidity in the case of process liquid including acidic substances as a coagulant, and corrodes the leaking portion in the case of leakage thereof.

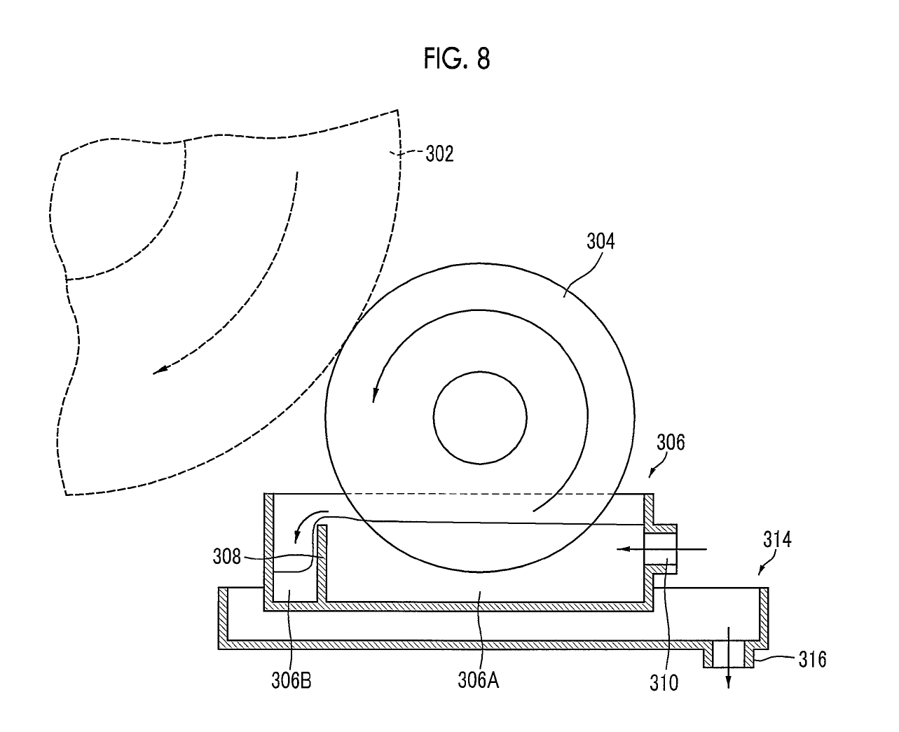

Consequently, when such process liquid showing strong acidity is used, as shown in FIG. 8, it is more preferably that a recovery plate 314 is installed below the process liquid vessel 306, and the process liquid leaking from the process liquid vessel 306 can be recovered.

The recovery plate 314 is formed to have a size capable of receiving the process liquid vessel 306, and is formed to be capable of recovering the process liquid leaking from the process liquid vessel 306 (which includes the process liquid leaking from the connection portion of the supply port 310 and the process liquid supply tube 404, or the process liquid leaking from the connection of the recovery port 312 and the process liquid recovery tube 406, in addition to the process liquid leaking beyond the outer circumferential wall surface).

In addition, a discharge port 316 is formed in the recovery plate 314 (formed in one of the corner portions of the bottom, in an example of FIG. 8). A waste liquid tube (not shown) connected to a waste liquid tank (not shown) is connected to the discharge port 316. The process liquid recovered by the recovery plate 314 is recovered to the waste liquid tank through the waste liquid tube.

Thereby, even when the process liquid showing strong acidity is coated, the coating operation can be safely performed for a long period of time without contaminating the periphery thereof.

In addition, in the above-mentioned embodiment, the process liquid is recovered by the process liquid recovery pump 410. However, when the process liquid tank 402 is installed below the process liquid vessel 306, for example, when the process liquid can be recovered by its own weight, the installation of the process liquid recovery pump can be omitted.

In addition, in the above-mentioned embodiment, although the temperature regulation unit 416 is installed in the midway of the process liquid recovery tube 406, the temperature can also be regulated in the process liquid tank 402. Meanwhile, when the distance from the process liquid tank 402 to the process liquid vessel 306 is long (when the path of the process liquid supply tube 404 is long), the temperature regulation unit 416 is preferably installed in the process liquid supply tube 404, as in the above-mentioned embodiment. Thereby, the temperature control can be easily performed. In this case, the temperature regulation unit 416 is more preferably installed close to the process liquid vessel 306 insofar as possible.

### Second Embodiment

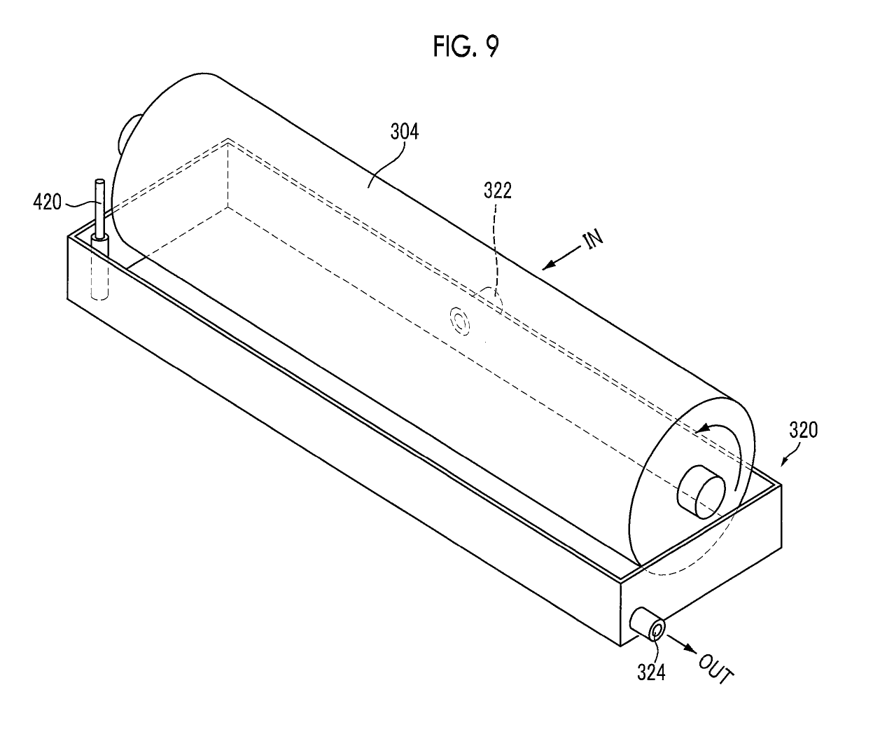

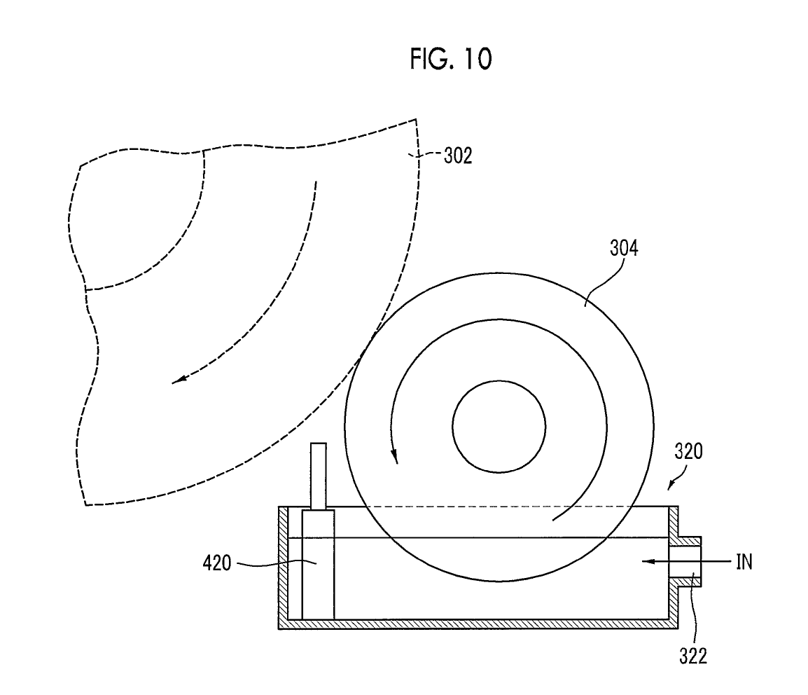

FIGS. 9 and 10 are a perspective view (perspective view of the process liquid vessel) and a cross-sectional view (cross-sectional view of the process liquid vessel and the drawing-up roller), respectively, illustrating main components according to a second embodiment of the coating device.

The coating device of the present embodiment detects the liquid level of the process liquid reserved in the process liquid vessel, and controls the supply and the recovery of the process liquid to the process liquid vessel so that the liquid level is always maintained constant.

Meanwhile, the above-mentioned coating device has basically the same configuration as that of the coating device 32 of the first embodiment, except that the configuration of the process liquid vessel is different, and the process liquid supply unit is provided with the liquid level detection sensor. Therefore, herein, only the configuration of the process liquid vessel and the supply control of the process liquid will be described.

[Configuration of Process Liquid Vessel]

As shown in FIGS. 9 and 10, a process liquid vessel 320 is formed in a rectangular dish shape, and the process liquid is reserved in the inside thereof.

Similarly to the process liquid vessel 306 of the above-mentioned first embodiment, a portion of (lower portion) of the drawing-up roller 304 is immersed in the process liquid vessel 320. That is, the drawing-up roller 304 draws up the process liquid reserved in the process liquid vessel 320, and supplies the process liquid to the coating roller 302. Therefore, the process liquid vessel 320 is formed corresponding to the drawing-up roller 304, and is formed to have an opening area and a depth capable of immersing a portion of the drawing-up roller 304.

As mentioned above, when the opening area of the process liquid vessel 320 is excessively large compared to the immersed portion of the drawing-up roller 304, the evaporation amount of the process liquid increases at that rate, and the decrease in the process liquid becomes rapid. Therefore, the opening area thereof is preferably made as small as possible. Specifically, when the immersed portion of the drawing-up roller 304 is received, the process liquid vessel is formed to have a size capable of forming a predetermined gap in the periphery of the immersed portion. This gap is preferably as small as possible, from the viewpoint of preventing the reserved process liquid from being evaporated.

A supply port 322 of the process liquid is formed in one of the wall surfaces in the longitudinal direction (width direction) which constitute the outer circumferential wall surface of the process liquid vessel 320, at the substantially central position in the longitudinal direction.

In addition, a recovery port 324 of the process liquid is formed in one of the wall surfaces in the lateral direction which constitute the outer circumferential wall surface of the process liquid vessel 320.

The process liquid is supplied from the supply port 322 to the process liquid vessel 320, and is recovered to the recovery port 324. The supply and the recovery of the process liquid are simultaneously performed, so that the process liquid is circulated and supplied to the process liquid vessel 320. In addition, the supply and the recovery of the process liquid is controlled, so that the amount (liquid level) of the process liquid reserved in the process liquid vessel 320 is controlled.

A liquid level detection sensor 420 that detects the liquid level (height from the bottom of the process liquid vessel) of the process liquid reserved in the process liquid vessel 320 is installed in the inside of the process liquid vessel 320. Information of the liquid level detected by the liquid level detection sensor 420 is output to the system controller 200.

The system controller 200 controls the driving of the process liquid supply pump 408 and the process liquid recovery pump 410 according to the output from the liquid level detection sensor 420, and controls the supply and the recovery of the process liquid to the process liquid vessel 320 so that the liquid level of the process liquid reserved in the process liquid vessel 320 is maintained constant.

Meanwhile, the above-mentioned coating device is the same as the coating device 32 of the first embodiment, in that the temperature sensor (not shown) is installed in the process liquid vessel 320, and the temperature control of the process liquid reserved in the process liquid vessel 320 is performed based on the output of the temperature sensor.

[Supply Control of Process Liquid]

As mentioned above, in the coating device of the present embodiment, the liquid level of the process liquid reserved in the process liquid vessel 320 is detected, and the supply and the recovery of the process liquid is controlled so the liquid level is maintained constant. Specifically, the control is performed as follows.

First, the process liquid supply valve 412 is opened, and the process liquid supply pump 408 is driven. Thereby, the process liquid is reserved in the process liquid vessel 320. When the process liquid is reserved up to a certain amount of height, the process liquid recovery valve 414 is opened, and the process liquid recovery pump 410 is driven. Thereby, the process liquid is recovered from the process liquid vessel 320. The supply and the recovery of the process liquid are performed, so that the process liquid is circulated and supplied to the process liquid vessel 320.

The system controller 200 controls the driving of the process liquid supply pump 408 and the process liquid recovery pump 410 based on the output of the liquid level detection sensor 420, and controls the supply and the recovery of the process liquid so that the liquid level of the process liquid is held at a previously set height.

As described above, in the coating device of the present embodiment, the supply and the recovery of the process liquid to the process liquid vessel 320 is controlled, so that the liquid level of the process liquid reserved in the process liquid vessel 320 is held constant.

Thereby, similarly to the coating device 32 of the above-mentioned first embodiment, the process liquid can be stably coated without unevenness. In addition, since the opening area of the process liquid vessel 320 is also suppressed to a small degree, the evaporation of the process liquid is also effectively suppressed.

Meanwhile, in the above-mentioned example, although the process liquid is supplied from one place and recovered from one place with respect to the process liquid vessel 320, the process liquid can be supplied from a plurality of places. Similarly, the process liquid can also be recovered from a plurality of places. That is, the liquid level can be uniformly controlled by controlling the supply and recovery.

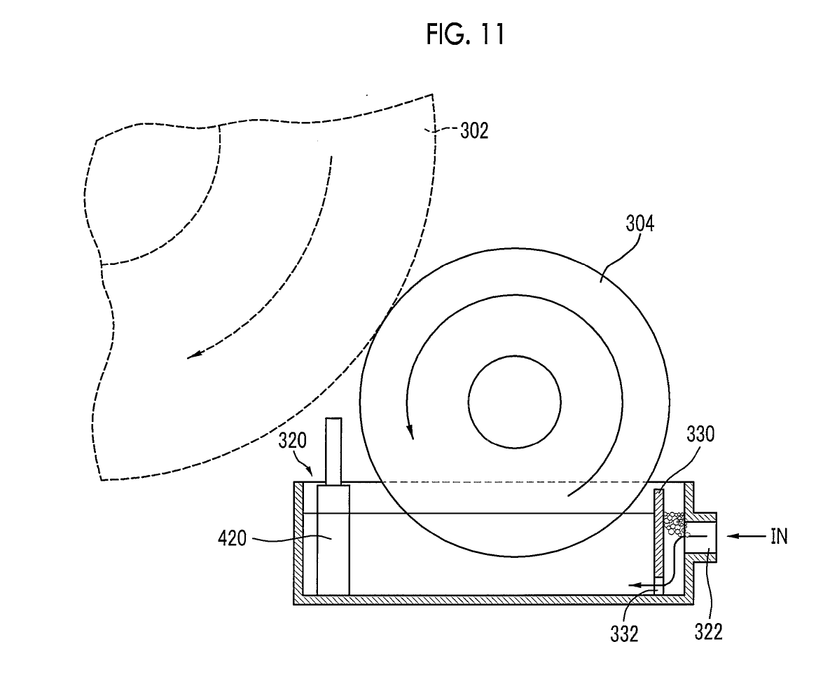

In addition, in the coating device of the present embodiment, it is preferable that the shielding plate 330 is installed in the inside of the process liquid vessel 320 as shown in FIG. 11, and foam can be prevented from being attached to the coating roller 302.

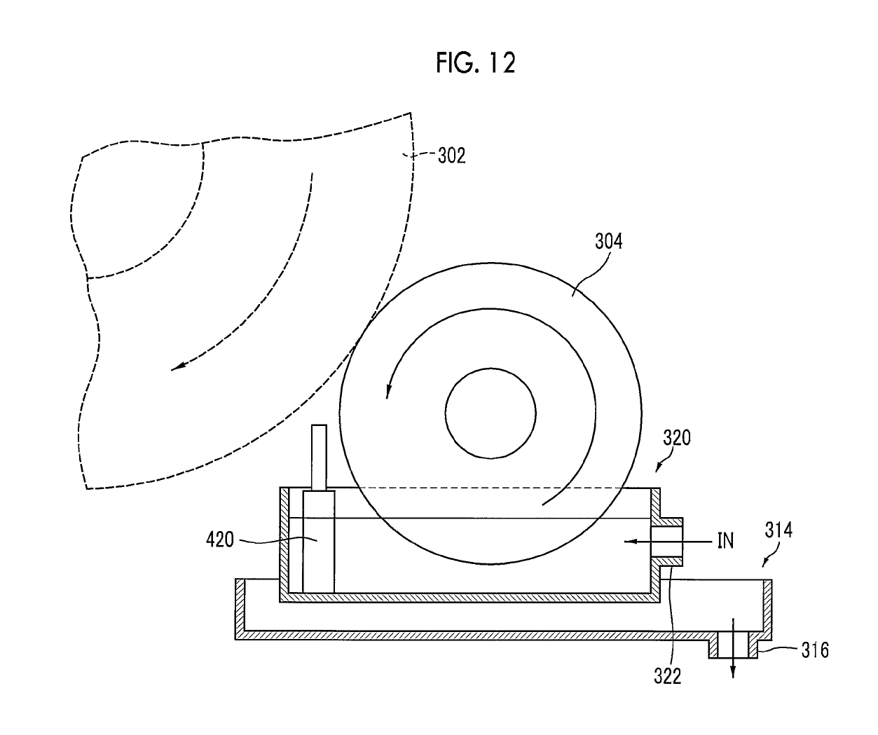

In addition, in the coating device of the present embodiment, it is preferable that the recovery plate 314 is installed below the process liquid vessel 320 as shown in FIG. 12, and the process liquid leaking from the process liquid vessel 320 can be recovered.

Thereby, even when the process liquid showing strong acidity is coated, the coating operation can be safely performed for a long period of time without contaminating the periphery.

### Other Embodiment

In the above-mentioned embodiment, although the process liquid drawn up by the drawing-up roller 304 is supplied directly to the coating roller 302, an intermediate roller is installed between the drawing-up roller 304 and the coating roller 302, and thus the process liquid may also be supplied to the coating roller 302 through this intermediate roller. A plurality of intermediate rollers may also be provided.

In addition, a blade is installed in the drawing-up roller 304 as necessary, and thus unnecessary process liquid may also be removed.

In a series of embodiments mentioned above, although a case in which the present invention is coated to the ink jet recording apparatus that performs printing on normal printing paper using aqueous ink has been described by way of example, the coating of the present invention is not limited thereto. The present invention can also be similarly coated to a printing apparatus that performs recording on paper other than the normal printing paper using an ink jet method. In addition, the present invention can also be similarly coated to a printing apparatus that performs recording using ink other than aqueous ink.

What is claimed is:

1. A coating device that coats process liquid to paper before printing, comprising:
a coating roller that coats the process liquid to the paper;
a process liquid vessel in which the inside thereof is partitioned into a reservoir and a recovery chamber by a partition plate having a predetermined height, a supply port of the process liquid is formed in the reservoir and a recovery port of the process liquid is formed in the recovery chamber, and the liquid level of the process liquid reserved in the reservoir is held constant by causing the process liquid supplied from the supply port to the reservoir to overflow from the partition plate to the recovery chamber;
process liquid supply unit that supplies the process liquid to the process liquid vessel through the supply port;
process liquid recovery unit that recovers the process liquid from the process liquid vessel through the recovery port; and
a drawing-up roller that draws up the process liquid reserved in the reservoir of the process liquid vessel to supply the process liquid to the coating roller.

2. The coating device according to claim 1, further comprising a process liquid tank that reserves the process liquid,
wherein the process liquid supply unit supplies the process liquid from the process liquid tank to the process liquid vessel, and the process liquid recovery unit recovers the process liquid from the process liquid vessel to the process liquid tank.

3. The coating device according to claim 1, wherein the process liquid vessel is formed in a rectangular dish shape having a width corresponding to a width of the drawing-up roller, the inside thereof being partitioned into the reservoir and the recovery chamber by the partition plate disposed parallel to a shaft of the drawing-up roller, and an opening area of the recovery chamber being formed so as to be smaller than an opening area of the reservoir.

4. The coating device according to claim 3, wherein the supply port is formed in an outer circumferential wall constituting the process liquid vessel, and a blocking member for blocking the flow of the process liquid from the supply port toward the coating roller on the liquid level is provided in the inside of the process liquid vessel.

5. The coating device according to claim 1, wherein a recovery plate that recovers the process liquid leaking from the process liquid vessel is included in the lower portion of the process liquid vessel.

6. The coating device according to claim 1, temperature regulation unit that regulates a temperature of the process liquid supplied to the process liquid vessel is included.

7. A coating device that coats process liquid to paper before printing, comprising:
a coating roller that coats the process liquid to the paper;
a process liquid vessel in which the process liquid is reserved;
a drawing-up roller that draws up the process liquid reserved in the process liquid vessel to supply the process liquid to the coating roller;
detection unit that detects the liquid level of the process liquid reserved in the process liquid vessel;
process liquid supply unit that supplies the process liquid to the process liquid vessel;
process liquid recovery unit that recovers the process liquid from the process liquid vessel; an 5
control unit that controls the supply of the process liquid by the process liquid supply unit and the recovery of the process liquid by the process liquid recovery unit, based on a detection result of the detection unit so as for the liquid level of the process liquid reserved in the process liquid vessel to be held constant.

8. The coating device according to claim 7, further comprising a process liquid tank that reserves the process liquid,
wherein the process liquid supply unit supplies the process liquid from the process liquid tank to the process liquid vessel, and the process liquid recovery unit recovers the process liquid from the process liquid vessel to the process liquid tank.

9. The coating device according to claim 8, wherein the process liquid vessel is formed in a rectangular dish shape having a width corresponding to a width of the drawing-up roller, a supply port of the process liquid is formed in an outer circumferential wall constituting the process liquid vessel, and a blocking member for blocking the flow of the process liquid from the supply port toward the coating roller on the liquid level is provided in the inside of the process liquid vessel.

10. The coating device according to claim 8, wherein a recovery plate that recovers the process liquid leaking from the process liquid vessel is included in the lower portion of the process liquid vessel.

11. The coating device according to claim 1, wherein temperature regulation unit that regulates a temperature of the process liquid supplied to the process liquid vessel is included.

12. An ink jet recording apparatus that ejects ink drops from an ink jet head toward paper transported by transport unit to draw an image, comprising the coating device according to claim 1.
